(19) United States
(12) Patent Application Publication
(10) Pub. No.: US 2009/0053127 A1
(43) Pub. Date: Feb. 26, 2009

(54) Process for the Partial Oxidation of Methane

(75) Inventors: Ian Allan Beattle Reid, London (GB); Geoffrey Benedict Smith, Surrey (GB)

Correspondence Address: NIXON & VANDERHYE, PC, 901 NORTH GLEBE ROAD, 11TH FLOOR, ARLINGTON, VA, 22203, US

(73) Assignee: INEOS EUROPE LIMITED, HAMPSHIRE (GB)

(21) Appl. No.: 11/795,823

(22) PCT Filed: Dec. 22, 2005
(86) PCT No.: PCT/GB05/05045

§ 371 Date: Jul. 1, 2008

(30) Foreign Application Priority Data
Jan. 21, 2005 (GB) 0501254.7

(51) Int. Cl. C01B 31/18

(52) U.S. Cl. 423/418.2

(57) ABSTRACT

The present invention provides a process for the production of carbon monoxide and hydrogen by partial oxidation of a methane-containing feedstock in the presence of a molecular oxygen-containing gas, wherein said process comprises (a) providing a pre-heated, mixed feedstream comprising said methane-containing feedstock and said molecular oxygen-containing gas, (b) subsequently mixing said pre-heated, mixed feedstream with a diluent, said diluent being pre-heated to a temperature of at least 400° C., to produce a diluent mixed feedstream comprising at least 10% by volume of diluent, and (c) contacting said diluent mixed feedstream with a catalyst suitable for the partial oxidation of the methane, to provide a product stream comprising carbon monoxide and hydrogen.

The present invention relates to a process for the partial oxidation of methane.

Methane catalytic partial oxidation is a well-known reaction for the production of carbon monoxide and hydrogen (also known as synthesis gas), which themselves may be used in the synthesis of a wide range of chemical compounds.

Processes for the catalytic partial oxidation of methane, and catalysts suitable therefore, are described, for example, in WO 01/46069, WO 01/81241, WO 99/35082, U.S. Pat. No. 4,844,837, EP-A-1 134 188 and EP-A-0 576 096.

In general, the methane catalytic partial oxidation comprises feeding a methane-containing feedstock, such as natural gas, with a molecular oxygen-containing gas over a catalyst in a reaction zone, typically a Group VIII metal catalyst, wherein partial oxidation of the methane occurs according to the following equation:

CH₄+0.5O₂→CO+2H₂ (1).

Steam may also be fed to the process. The steam will react with carbon monoxide formed according to the water-gas shift reaction (below), increasing the amount of hydrogen produced and reducing the amount of carbon monoxide produced:

CO+H₂O CO₂+H₂ (2).

The addition of steam to increase hydrogen production (and the addition of carbon dioxide to promote carbon monoxide production by the reverse reaction) is described, for example, in WO 99/35082.

We have now found that the partial oxidation of methane may be advantageously operated by diluting a pre-mixed and pre-heated methane and molecular oxygen containing feed with a suitable pre-heated diluent prior to contact with the methane partial oxidation catalyst.

Hence, in a first aspect, the present invention provides a process for the production of carbon monoxide and hydrogen by partial oxidation of a methane-containing feedstock in the presence of a molecular oxygen-containing gas, wherein said process comprises
(a) providing a pre-heated, mixed feedstream comprising said methane-containing feedstock and said molecular oxygen-containing gas,
(b) subsequently mixing said pre-heated, mixed feedstream with a diluent, said diluent being pre-heated to a temperature of at least 400° C., to produce a diluted mixed feedstream comprising at least 10% by volume of diluent, and
(c) contacting said diluted mixed feedstream with a catalyst suitable for the partial oxidation of the methane, to provide a product stream comprising carbon monoxide and hydrogen.

Step (a) of the process of the present invention comprises providing a pre-heated, mixed feedstream comprising methane-containing feedstock and molecular oxygen-containing gas. The pre-heated, mixed feedstream may be produced by any suitable method, but, due to flammability constraints is preferably produced by:
(i) separately pre-heating said methane-containing feedstock and said molecular oxygen-containing gas, and
(ii) mixing the pre-heated methane-containing feedstock and pre-heated molecular oxygen-containing gas to produce said pre-heated, mixed feedstream.

The methane-containing feedstock and the molecular oxygen-containing gas may be pre-heated to any suitable temperatures before mixing with each other. Advantageously, one or more heat exchangers may be employed to pre-heat the methane-containing feedstock and molecular oxygen-containing gas prior to mixing.

Generally, the amount of pre-heating that can be performed is limited to temperatures wherein the pre-heated, mixed feedstream will be below the autoignition temperature of the mixture. This is usually significantly below the reaction temperature obtained when the mixed feedstream contacts the catalyst.

Typically, the methane-containing feedstock is pre-heated to less than 700° C.

Typically, the molecular oxygen-containing is pre-heated to less than 150° C., preferably less than 100° C.

Typically, the pre-heated, mixed feedstream will be at a temperature of less than 600° C., such as 500° C. to 600° C.

Preferably the pre-heated mixed feedstream comprises methane-containing feedstock and molecular oxygen-containing gas at a ratio of methane to molecular oxygen-containing gas of 1:1 to 4:1, preferably in the range 2:1 to 3:1.

In step (b) of the process of the present invention, the mixed feedstream is mixed with a diluent, said diluent being pre-heated to a temperature of at least 400° C., to produce a diluted mixed feedstream comprising at least 10% by volume of diluent.

A heat exchanger may be employed to pre-heat the diluent prior to mixing.

Typically, the diluted mixed feedstream comprises 20 to 70% by volume of diluent, such as 40 to 50% by volume.

The diluent may be pre-heated to at least 600° C., such as at least 700° C.

Preferably, the diluted mixed feedstream produced will be at a temperature of at least 600° C., such as at least 700° C.

The diluent may be a single material or may comprise a mixture of materials.

Most preferably, the diluent comprises at least 80% by volume, preferably at least 90% by volume, of steam, carbon dioxide, an inert gas, such as helium, neon, argon or nitrogen, or a mixture thereof.

Carbon dioxide, for example, may be obtained as a by-product from the methane partial oxidation reaction of step (c).

The diluent is mixed with the mixed feedstream immediately before the diluted mixed feedstream contacts the catalyst, preferably within 100 ms. Preferably, the diluted mixed feedstream is contacted with the catalyst within 50 milliseconds of the diluent being mixed with the pre-heated mixed feedstream, and more preferably within 10 ms. For avoidance of doubt this time is measured from the time of first contact of diluent with the pre-heated mixed feedstream.

The mixing and rapid contact with the catalyst is achieved by providing a suitable source for the diluent located relatively close to the surface of the catalyst bed and/or to any catalyst holder.

The diluent may be mixed with the mixed feedstream using any suitable mixing device. One such device that may be used is a diffusion-bonded block formed by diffusion bonding of layers of etched metal structures. Such structures are known for heat exchange uses, and are described generally, for example, in “Industrial Microchannel Devices—Where are we Today?”; Pua, L. M. and Rumbold, S. O.; First International Conferences on Microchannels and Minichannels, Rochester, N.Y., April 2003.

A preferred method of introducing the diluent is by use of a sparger having at least 4 outlets distributed close to the top face of the catalyst (or catalyst holder).

A most preferred diluent comprises steam, such as 20 to 100% by volume, preferably 50 to 100% by volume of steam.

In one embodiment, the product stream comprising carbon monoxide and hydrogen from the methane partial oxidation reaction may be subsequently reacted to produce hydrocarbons, such as in a Fischer-Tropsch reaction, in which case steam may be obtained from these subsequent processes.

Steam has the added advantage that it will inhibit formation of pyrolytic carbon on the catalyst. Steam (water) is also easily separable from the methane partial oxidation product stream comprising carbon monoxide and hydrogen.

In one embodiment, the pre-heated diluent comprising steam may be produced by providing a stream comprising hydrogen and molecular oxygen, which react to produce steam (water) and generate the heat required to heat the stream to the required pre-heat temperature.

In an alternative embodiment, the pre-heated diluent comprising steam may be produced by providing a stream comprising methane (and optionally hydrogen) and reacting this with molecular oxygen, to produce a hot stream comprising steam (water), carbon dioxide and, optionally, any unreacted methane, at least some of which is used as the pre-heated diluent.

The hot stream comprising steam produced from hydrogen and molecular oxygen or steam, carbon dioxide and any unreacted methane produced from methane and molecular oxygen is typically initially at a temperature of much higher than 400° C. and, hence, much higher than that required for the diluent stream. The stream may be cooled by heat 25, exchange and/or diluted to produce the diluent stream of the desired temperature. Where the stream is cooled by heat exchange the heat removed may be used as pre-heat for other feeds to the process, such as the methane-containing feedstock and/or the molecular oxygen-containing gas.

Preferably, where steam is used as the diluent at least some of the steam may be obtained from downstream processing steps, such as cooling of the product stream from the methane partial oxidation reaction.

In general, the dilution of the mixed feedstream by the diluent allows the reaction to be operated at relatively low partial pressures of the methane-containing feedstock (compared to the total pressure), which can lead to improved methane conversion anD0020 improved selectivity to carbon monoxide and hydrogen. A lower partial pressure of methane-containing feedstock will also lead to a reduced partial pressure of products in the product stream, which will reduce further reactions taking place in the product stream.

The use of a hot diluent reduces the heating requirements of the mixed feedstream compared to addition of a cold diluent. The use of a hot diluent which is mixed with a mixed (methane and molecular oxygen-containing) feedstream to produce a diluted mixed feedstream immediately before the diluted mixed feedstream contacts the catalyst allows a significant amount of heat to be introduced to the reaction mixture with significantly reduced flammability issues compared to if the hot diluent were introduced earlier in the mixing process (when the residence time of the diluted mixed feedstream may exceed the ignition delay time for a particular feedstream), allowing a higher temperature diluted mixed feed to be obtained. Mixing the hot diluent immediately before the diluted mixed feedstream contacts the catalyst also reduces opportunities for heat loss from the mixed stream, improving the efficiency of the heat introduction.

The use of a hot diluent also has advantages in the start-up and shut-down of the partial oxidation reaction. During start-up, the hot diluent can be introduced to the catalyst before the reactants, causing the catalyst to be pre-heated to the temperature of the diluent. When the reactants are introduced the catalyst rapidly heats to reaction temperature. Because the catalyst is already at a higher temperature from use of hot diluent prior to introduction of the reactants, the thermal stresses across the catalyst on initiation of reaction are reduced.

Similarly, on shut-down, the thermal stresses across the catalyst can be reduced by using the hot diluent, optionally with a purge gas such as nitrogen, rather than the purge gas alone.

In step (c) of the present invention the diluted mixed feedstream is contacted with a catalyst suitable for the partial oxidation of the methane.

The catalyst suitable for the partial oxidation of the methane usually comprises a Group VIII metal. Suitable catalysts comprising a Group VIII metal include catalysts comprising rhodium, platinum, palladium, nickel or mixtures thereof, such as rhodium/platinum.

The reaction may suitably be carried out at a catalyst exit temperature in the range 600° C. to 1200° C., preferably, in the range 850° C. to 1050° C. and, most preferably, in the range 900° C. to 1000° C.

The process of the present invention is preferably operated at a pressure of at least 20 barg.

The process of the present invention is preferably operated at a partial pressure of methane-containing feedstock and molecular oxygen containing gas in the diluted mixed feedstream of greater than 10 barg.

The methane-containing feedstock is preferably natural gas, which comprises predominantly methane but may also comprise smaller amounts of other hydrocarbons, such as ethane, propane and butane.

Any suitable molecular oxygen-containing gas may be used. Suitably, the molecular oxygen-containing gas is molecular oxygen, air and/or mixtures thereof. The molecular oxygen-containing gas may be mixed with an inert gas such as nitrogen or argon.

The diluted mixed feedstream is passed over the catalyst at a gas hourly space velocity which is pressure dependent and typically greater than 100000 hr⁻¹ bar⁻¹. It will be understood, however, that the optimum gas hourly space velocity will depend upon the nature of the feed composition.

1. A process for the production of carbon monoxide and hydrogen by partial oxidation of a methane-containing feedstock in the presence of a molecular oxygen-containing gas, wherein said process comprises
(a) providing a pre-heated, mixed feedstream comprising said methane-containing feedstock and said molecular oxygen-containing gas,
(b) subsequently mixing said pre-heated, mixed feedstream with a diluent, said diluent being pre-heated to a temperature of at least 400° C., to produce a diluent mixed feedstream comprising at least 10% by volume of diluent, and
(c) contacting said diluent mixed feedstream with a catalyst suitable for the partial oxidation of the methane, to provide a product stream comprising carbon monoxide and hydrogen.

2. A process as claimed in claim 1, wherein the diluted mixed feedstream comprises 20 to 70% by volume of diluent, such as 40 to 50% by volume.

3. A process as claimed in claim 1 or claim 2, wherein the diluent comprises at least 80% by volume of materials which are inert in the process of the present invention.

4. A process as claimed in claim 3, wherein the diluent comprises steam, carbon dioxide, an inert gas, such as helium, argon or nitrogen, or a mixture thereof.

5. A process as claimed in claim 4, wherein the diluent comprises steam.
